(19) United States
(12) Patent Application Publication
(10) Pub. No.: US 2005/0073539 A1
(43) Pub. Date: Apr. 7, 2005

(54) Ink placement adjustment

(76) Inventors: Mark McGarry, San Diego, CA (US); Josep-Maria Serra, San Diego, CA (US); Antoni Mucia, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/680,033

(22) Filed: Oct. 7, 2003

(51) Int. Cl. B41J 29/38

(52) U.S. Cl. 347/14; 347/19

(57) ABSTRACT

Systems, methods, and devices are provided for printhead adjustment. In one apparatus embodiment, the apparatus includes an image scanning mechanism and a controller. The image scanning mechanism can provide positioning data about the position of drops of ink ejected onto media from nozzles of a number of stationary printheads. The controller can determine a Y axis offset of at least two ink drops based on the positioning data.

Industrial and commercial printing systems employ the use of inkjet printing devices having multiple printheads for high volume print jobs. Commercial ink-jet printing devices, such as fixed wide-array inkjet printing devices, use an array of non-scanning printheads arranged in a parallel configuration that can span the width of the print media perpendicular to the direction of media travel. The printheads can be arranged in a staggered configuration and held stationary relative to the print media as a non-continuous form such as a cut sheet, and/or continuous form, such as a continuous web of print media, is advanced passed the printheads. Some staggered printhead arrays can contain up to 32 printheads and thus the alignment issues can be large, especially where printhead adjustment is performed manually. Printheads are adjusted to achieve correct ink placement on the media.

Other mechanical considerations include the adjustment of the printheads relative to one another. The printheads are each typically positioned in a printhead stall. Mechanical positioning of the printheads in each stall relative to one another can present an issue of print quality degradation due to the nature of manual installation of printheads within printhead stalls.

### BRIEF DESCRIPTION OF THE DRAWINGS

FIG. 1 illustrates an embodiment of a printing system.

FIG. 2 illustrates an embodiment of an optical sensor.

FIGS. 3A, 3B, and 3C illustrate examples of techniques that can be used to identify X, Y, and/or rotational offsets of an ink placement pattern.

FIG. 4 illustrates another embodiment for adjusting nozzles on a printing device.

FIG. 5 illustrates a method embodiment for printhead adjustment.

FIG. 6 illustrates a method embodiment for printhead adjustment.

FIG. 7 illustrates an embodiment of an imaging system.

### DETAILED DESCRIPTION

Embodiments disclosed herein provide a user with an automated method to adjust placement of ink drops of staggered, stationary printhead arrays. As used herein, the term “staggered, stationary printheads” can include printheads that are stationary, and configured in a staggered manner such that some printheads are positioned offset relative to other printheads. The printheads can be positioned within non-moving stalls such that the printheads remain stationary during printing.

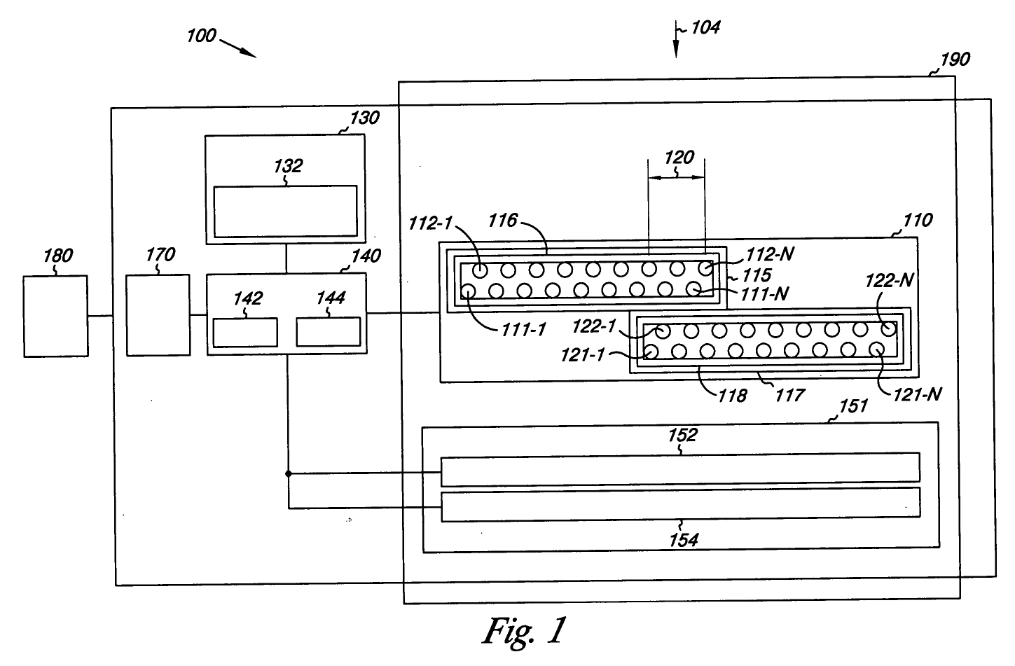

FIG. 1 illustrates an embodiment of a printing system 100, which includes a staggered, stationary inkjet printhead assembly 110. In the embodiment of FIG. 1, two staggered printheads, shown as 116 and 118, are positioned within two separate printhead stalls 115 and 117. The staggered printheads 116 and 118 eject drops of ink through a plurality of orifices or nozzles, for example, nozzles 111-1 through 111-N, and onto a print media 190 so as to form a printed image onto print media 190. In the embodiment of FIG. 1, the nozzles are arranged in two columns. It is understood, however, that various embodiments can include printheads having one or more columns of nozzles. Since the printheads are positioned horizontally and perpendicular to the direction of media travel, columns of nozzles appear as rows due to the horizontal, rather than the vertical, positioning within printhead stalls 115 and 117.

In the embodiment shown in FIG. 1, the first stall 115 is a stationary mechanical mounting device for receiving first printhead 116 and for positioning the first printhead 116 within the printing device 100. However, the embodiments of the invention are not limited to the use of stalls, to the number of stalls, or the number of printheads with each stall. The first printhead 116 includes a first nozzle column including nozzles 111-1 through 111-N and a second nozzle column including nozzles 112-1 through 112-N with both nozzle columns linearly positioned on first printhead 116.

A second stall 117 is a stationary mechanical mounting device for receiving second printhead 118 and for positioning second printhead within the printing device 100. The second printhead includes nozzles 121-1 through 121-N and nozzles 122-1 through 122-N. Nozzle 121-1 through nozzle 121-N can be configured in a parallel and staggered position relative to nozzles 122-1 through 122-N.

The second stall 117 is positioned offset in the X direction and parallel to the first stall 115 thus creating a nozzle overlap zone 120 between the nozzles of first printhead 116 and the nozzles of second printhead 118. In various embodiments, printheads are spaced apart and staggered such that the nozzles of each printhead overlap the nozzles of one or more adjacent printheads to permit coverage of ink drop placement on the print media. The nozzle overlap zone 120 bounds a varying number of rightmost nozzles of first printhead 116 and a varying number of leftmost nozzles of second printhead 118 such that the overlap zone, if all of the nozzles are ejecting ink, may produce a banding effect due to redundant ink drop ejection in the nozzle overlap zone 120. Embodiments of the present invention reduce redundant ink drop ejection within nozzle overlap zone to reduce the banding effect of staggered printheads. As shown in FIG. 1, the second stall is positioned offset in the Y direction in order to physically accommodate the overlap of nozzles.

In the embodiment shown in FIG. 1, the printing system includes a controller 140. The controller 140 can include memory 142 and a processor 144 and can be electrically coupled to a printhead array 110, a paper path mechanism 130 (e.g., such as a media motor), an illuminator 152, an optical sensor 154, and a user interface 170 (e.g., such as a display and keyboard combinations, touch screen, or other interface mechanism).

The controller 140 can receive printing instructions from a number of sources including a user interface 170 available on the printing system 100 or from a remote device 180. The controller 140 can use a processor 144 to execute printing instructions according to, for example, software (e.g., computer executable instructions) stored in memory 142.

The memory 142 in controller 140 can likewise include software having executable instructions to execute an algorithm which controls the ejection of ink from the nozzles of the printheads 116 and 118 to print an ink placement pattern, i.e., ink pattern, on print media 190. Memory 142 can include some combination of ROM, dynamic RAM, magnetic media, and optically read media, and/or some type of non-volatile and writeable memory such as battery-backed memory or flash memory.

The memory can store data including software, printing instructions, and data sent from the image scanning mechanism 151. The memory can be accessed by the processor 144, as shown in FIG. 1, which can process the data stored in memory. The processor 144 can operate on the data received from the image scanning mechanism 151 to adjust the time for ejecting ink droplets from nozzles on printheads 116 and/or 118.

The memory 142 in controller 140 can also include software to control the operation of the paper path mechanism 130 for advancing print media 190. FIG. 1 illustrates an embodiment of a paper path mechanism 130 having a media position encoder 132. The encoder 132 can measure the position of the print media 190 relative to the staggered, stationary printhead array 110 and the optical sensor 154.

The encoder can be of any suitable type. For example, the encoder can be a rotational encoder that rotates with the movement of the print media to indicate print media positioning. The rotational encoder generates a signal based upon the rotation, which can represent a measurable distance of print media advancement. The media position encoder 132 sends print media positioning data back to the controller 140 as the ink placement pattern is printed and the media is advanced 104. The controller 140 can use the print media advance data to control the timing of printhead ink ejection.

The memory 142 in controller 140 can also include software to control the operation of an illuminator 152 and an optical sensor 154 to illuminate print media 190 and capture reflected light containing data. FIG. 1 illustrates an embodiment of an illuminator 152 and optical sensor 154 that are housed in an image scanning mechanism 151. As understood by one of ordinary skill in the art, an image scanning mechanism 151 can read a printed page and convert it into computer readable data by illuminating print media 190 with illuminator 152 and capturing reflected light containing data with optical sensor 154.

To control the timing of printhead ink ejection, the controller 140 can, for example, send instructions to an image scanning mechanism 151 to scan an ink placement pattern on the print media using the illuminator 152 and optical sensor 154. The optical sensor 154 can capture reflected light from the illuminated printed ink placement pattern as it advances passed the illuminator 152 and convert the reflected light from the illuminated ink placement pattern into digital data. The digital data can be sent to the controller's memory 142. The processor 144 uses software to process the digital data and determine the position of the ink placement pattern relative to the print media and/or placement of ink from a nozzle with respect to another nozzle.

As will be described in more detail below, the controller can cause a reference line to be printed on the printed media as well. The reference line can be used in conjunction with the ink placement pattern to determine ink placement adjustment. As mentioned above, the controller 140 can adjust the timing of the ink ejection by executing software instructions which can vary nozzle ink ejection timing in a Y-axis direction or to create a rotational offset for ink ejection timing, as described more below. In other words, software embodiments executable by the controller 140 can use ink placement data received from the image scanning mechanism 151 to control the timing of the ejection of ink from the nozzles of the printheads to achieve a particular ink placement (e.g., to correct for mechanical misalignment between printheads 116 and 118 which causes improper ink drop ejection onto print media 190). In the X-axis direction, software can operate on the received data to turn nozzles on and off based on the ink placement data.

A user interface 170 is also illustrated in FIG. 1. The user interface 170 can provide controls for a user to initiate printhead adjustment or to program the printer to perform automatic printhead adjustment.

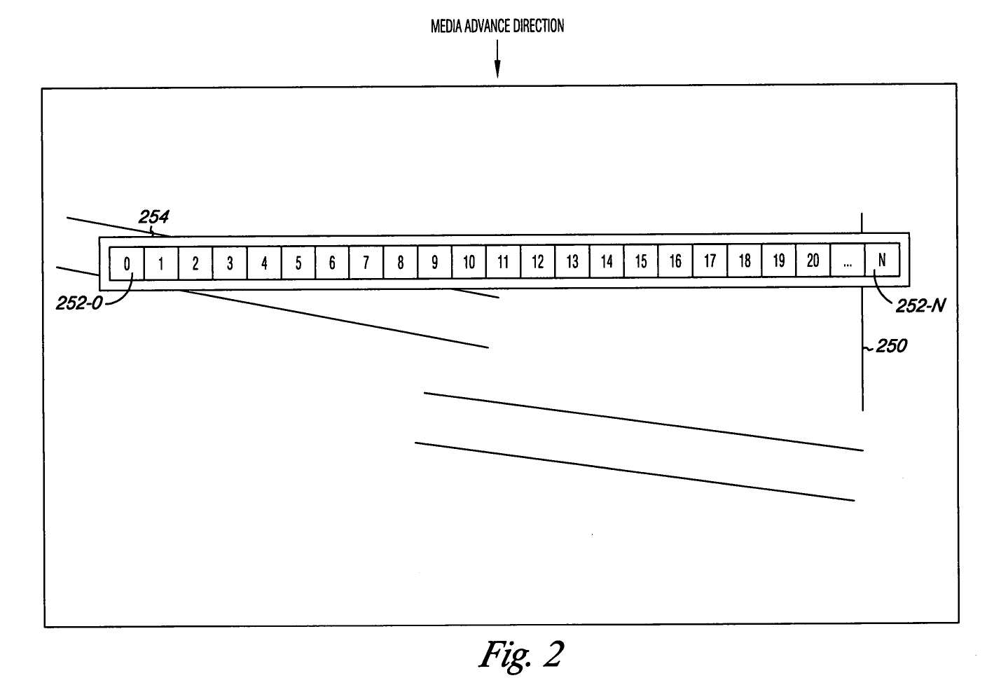

FIG. 2 illustrates an embodiment of an optical sensor 254 and a reference line 250. The optical sensor 254 can be a high-resolution optical sensor and can serve as an optical sensor 154 such as that shown in FIG. 1. In the embodiment of FIG. 2, an optical sensor 254 includes a plurality of Charged Coupled Devices (“CCD”) shown as elements 252-0 through 252-N that can be spaced at a fixed pitch in a linear fashion as the same will be understood by one of ordinary skill in the art. For example, CCD elements 252-0 to 252-N can be spaced at a fixed pitch of 2,400 CCD elements per linear inch. However, the illustration is enlarged to show the detail of the CCD elements with respect to the reference line 250. It is understood however, that any number of CCD elements can be used.

By way of example, and not by way of limitation, reference line 250 can be a vertical line printed by repeatedly ejecting ink from a nozzle on one of the printheads (e.g., the right most nozzle of the second column 122-N of second printhead 118). The reference line 250 is shown substantially parallel to the direction of media travel. Also shown are the ink placement pattern lines, as discussed in more detail below. Software associated with the image scanning mechanism can be capable of encoding ink placement relative to the location of the optical sensor as it is scanned over the media. For example, the left most image scanning mechanism element 252-0 of the optical sensor can be used as a spatial reference point relative to which the positions of ink drop lines are measured.

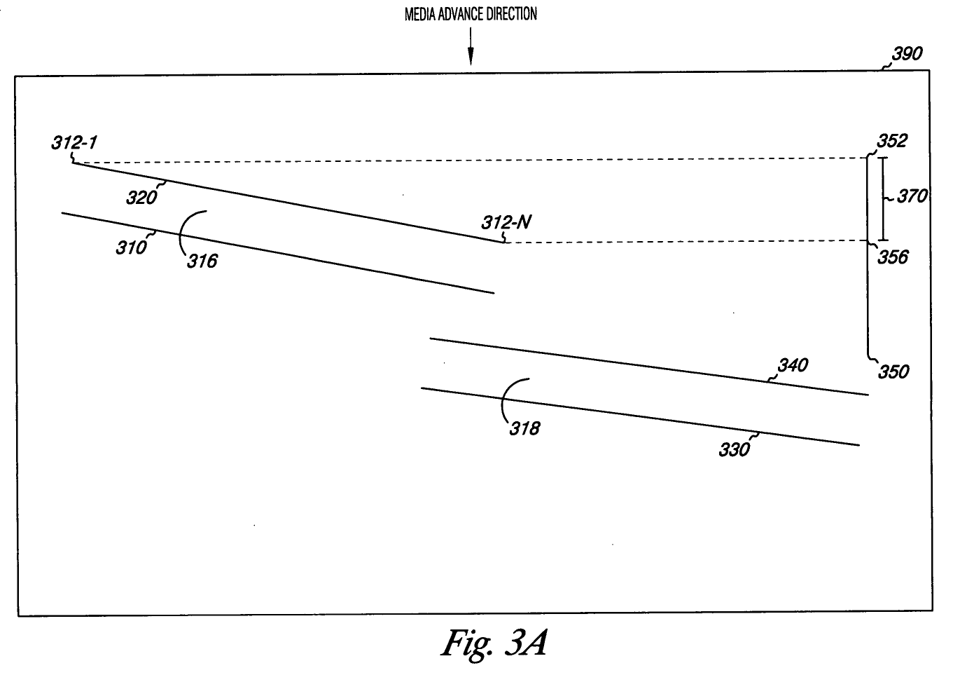

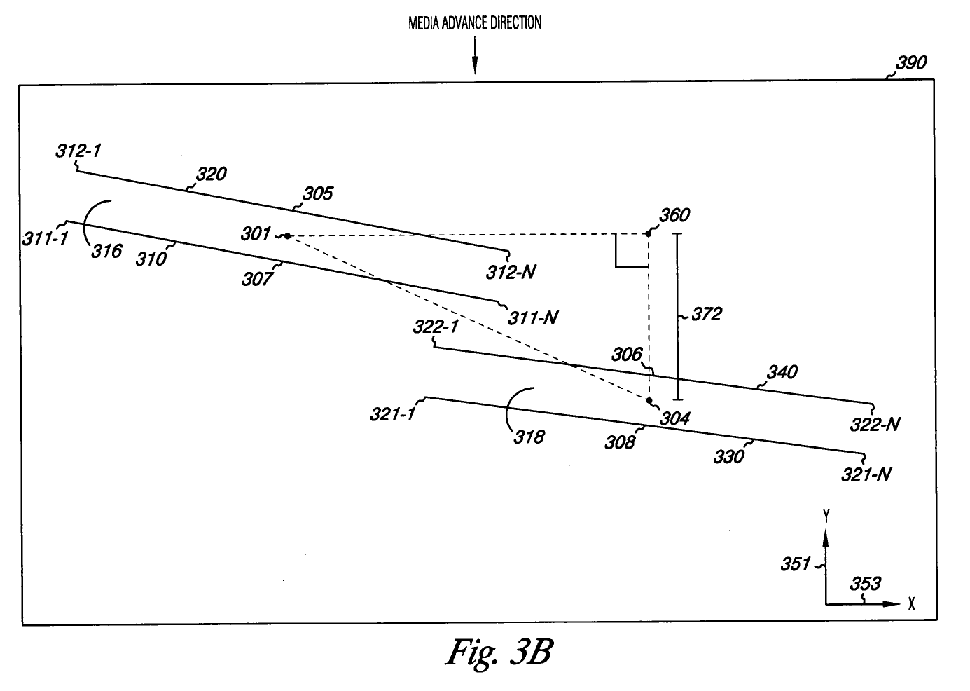

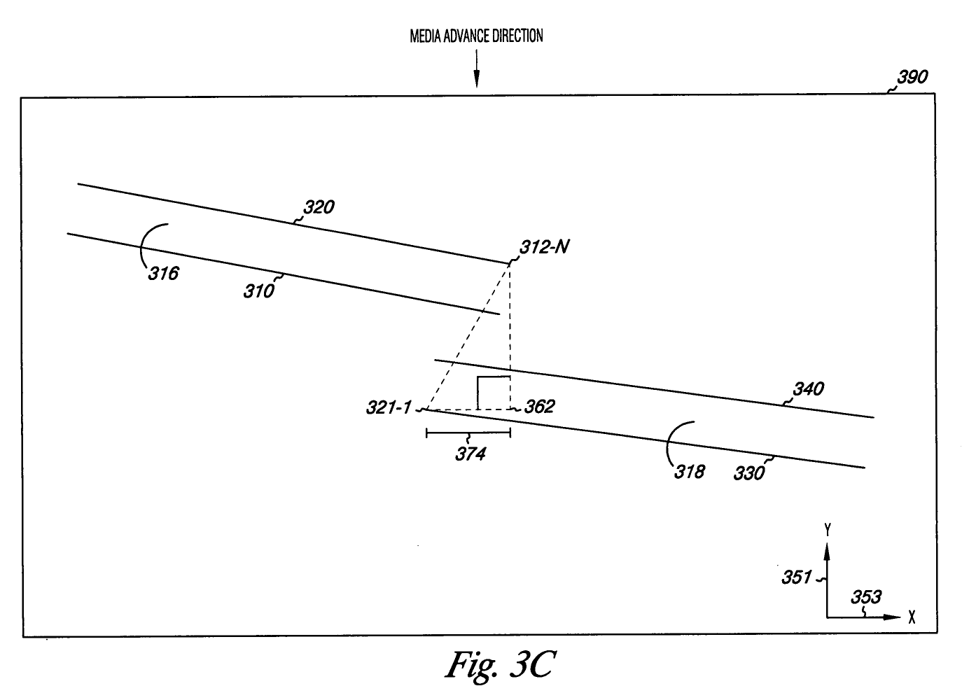

FIGS. 3A, 3B, and 3C illustrate examples of techniques that can be used to identify X, Y, and/or rotational offsets of an ink placement pattern. For illustrative purposes, the ink placement pattern shown in FIG. 3A is represented by four lines positioned offset relative to a reference line. The ink placement patterns in FIGS. 3B and 3C are represented by four lines positioned offset relative to a Y-axis direction and an X-axis direction. The offset lines provide an example of ink drop ejections from all nozzles of two misaligned printheads where the printheads may be mechanically misaligned, where printhead ink drop ejection timing may be incorrect, or where an incorrect number of nozzles in an overlapping area between printheads may be ejecting ink. However, the embodiments are not limited to adjustment of printheads where all nozzles of all printheads are ejecting ink. Embodiments can have less than all nozzles of all printheads ejecting ink and embodiments can use less than all printheads.

In the embodiments illustrated in FIGS. 3A, 3B, and 3C, software, firmware, logic, among others, and/or a combination thereof, may be used by a controller to control nozzle ink ejection timing to adjust ink placement on print media. In FIGS. 3A, 3B, and 3C adjustment examples including ink placement patterns and reference lines and points are illustrated. The ink placement patterns are scanned and the data produced is operated on by the controller to calculate various offsets to adjust the ink ejection timing of printhead nozzles to adjust ink placement from stationary, staggered printhead arrays and/or individual printheads and/or to adjust the number of nozzles that eject ink.

By way of example and not by way of limitation, FIG. 3A illustrates an ink placement pattern such as may be scanned. The scanned data may be operated upon by software in the controller to adjust a rotational offset, i.e., angular offset, relative to a reference line. FIGS. 3B and 3C illustrate an embodiment of the manner in which scan data of the ink placement patterns can be used to adjust a linear offset distance of ink placement in the Y-direction between printheads, and a linear offset distance of ink placement between printheads in an X-axis direction respectively. In FIGS. 3A-3C, the linear offsets are measured relative to an X and Y-axis. The X-axis represents a direction perpendicular to the direction of print media advancement. The Y-axis represents a direction parallel to the direction of print media advancement.

A variety of methods can be used to determine rotational offsets and/or linear offsets. For example, different endpoints, which are represented by the leftmost and right most nozzles in each column of each printhead, within and among printheads, can be used to calculate the X and Y coordinates of those endpoints in determining rotational and linear offsets.

In the embodiment of FIG. 3A, scanned data of the ink placement pattern can be operated on by software embodiments of the invention to calculate a rotational offset distance 370 relative to a reference line 350. In the embodiment of FIG. 3A, the ink placement pattern is intended to be horizontal, e.g., perpendicular to the direction of media travel. As illustrated, the ink placement pattern lines are not perpendicular, but askew which represents a misalignment of ink placement.

As used herein, a misalignment can occur when the nozzles of a printhead are not mechanically positioned properly with respect to a media advance direction or the nozzles of an adjacent printhead. Misalignment can exist between printheads when the nozzles of a first printhead are spatially positioned relative to the nozzles of a second printhead such that ink drops ejected from the nozzles of the first printhead do not fall onto the media in the desired location relative to the ink drops ejected from the nozzles of the second printhead. Misalignment in the Y-axis direction and rotational offset misalignment can be reduced by adjusting the timing of nozzle ink ejection. Misalignment in the X-axis direction can be reduced by disabling nozzles that cause redundant ink drop ejection within nozzle overlap zone 120.

The embodiment of FIG. 3A can represent an exaggerated ink placement pattern, e.g., much more out of alignment than typically experienced for purposes of ease of illustration. The embodiment in FIG. 3A shows an ink placement pattern consisting of four solid lines 310, 320, 330, and 340 with a rotational offset relative to a vertical reference line 350. In the embodiment shown, the vertical reference line 350 is a solid vertical line in the Y-axis direction printed by at least one nozzle on the second printhead 318. The four solid lines, appearing to have a rotational offset relative to the vertical line 350, are printed on print media 390 using two stationary, staggered printheads 316 and 318 with two nozzle columns on each printhead, however, the embodiments of the invention are not so limited. That is, the ink placement pattern show four lines that appear as solid lines which are formed by the ejecting of ink drops from all nozzles in the two nozzle columns of the two printheads with each line formed from a different column of nozzles.

The image scanning mechanism 151, as shown in FIG. 1, can detect the ink placement pattern 300 and the vertical reference line 350. Software can be used to interpret data detected from the image scanning mechanism regarding the ink placement of the ink pattern. In the embodiment shown in FIG. 3A, an image of the ink placement pattern is scanned by an image scanning mechanism and digital data representing the ink placement pattern is sent to memory, such as memory shown in FIG. 1. The data can be analyzed by identifying X and Y coordinates of the endpoints 312-1 and 312-N. Software embodiments can calculate intersecting points 352 and 356, positioned horizontally to the endpoints 312-1 and 312-N and intersecting vertical reference line 350, can be calculated respectively.

The rotational offset of first printhead 316 can be calculated by measuring the distance between the intersecting points 352 and 356. The distance measured 370 represents the rotational offset of the printed lines printed by printhead 316 from the vertical reference line 350. The offset distance 370 data can be calculated and instructions can be sent, for example by software, for adjusting nozzle ink ejection timing according to the offset distance, to the processor, such as the processor 144 shown in FIG. 1. For instance, the processor, e.g., 144 of FIG. 1, can provide a controller with alignment data to adjust the timing of ink ejection of first printhead 316 when printed lines in the X-axis direction 353 are determined by measurement not to be horizontal or perpendicular to the reference line, thus indicating a rotational offset, i.e., angular offset. The controller can adjust the timing of the ejection of ink drops according to the rotational offset in the Y-axis direction 351 such that printed lines in the X-axis direction 353 can be printed substantially horizontal, i.e., substantially perpendicular relative to the vertical reference line 350 after the adjustment is performed. Achieving substantially horizontal and substantially perpendicular alignment refers to the degree to which the printing system used (in this example, printing system 100) corrects for misalignment of a printhead from horizontal or perpendicular alignment.

In the embodiment shown in FIG. 3B, a linear offset distance 372 can be calculated between printheads in the Y-axis direction 351. The embodiment in FIG. 3B shows an ink placement pattern with a linear offset between two staggered, stationary printheads 316 and 318. The four solid lines 310, 320, 330, and 340 illustrate an ink placement pattern on print media 390 printed by two staggered, stationary printheads 316 and 318. The four solid lines 310, 320, 330, and 340 appear offset in both an X-axis 353 direction and a Y-axis direction 351. However, for purposes of illustration and not for limiting the embodiments, in the embodiment of FIG. 3B, adjustment of the two printheads is illustrated with respect to the Y-axis direction 351.

In various embodiments, an image scanning mechanism, such as the image scanning mechanism 151 shown in FIG. 1, can detect the ink placement pattern and software can operate on data regarding the ink placement that is received from the image scanning mechanism. In the embodiment shown in FIG. 3B, a linear offset can be calculated between printheads in a Y-axis direction 351. Ink placement pattern can be scanned by the image scanning mechanism. The ink placement pattern data can be sent, for example, to memory, such as memory 142 shown in FIG. 1. The data can be analyzed by a software program that operates on the data, for example, by identifying the X and Y coordinates of the center 301 of the first printhead 316 and the center 304 of the second printhead 318, however, embodiments of the invention are not so limited.

To determine the center 301 of the first printhead 316, the software calculates a midpoint 307 between nozzles 311-1 and 311-N by measuring the distance between nozzles 311-1 and 311-N, dividing the distance by a factor of two, and measuring the divided distance originating from one of nozzles 311-1 and 311-N and toward the other nozzle. The midpoint 305 between nozzles 312-1 and 312-N can be calculated by dividing the distance between nozzles 312-1 and 312-N by a factor of two. The software can calculate the center 301 of the first printhead 316 by calculating the distance between the midpoints 305 and 307, dividing that distance by two, and measuring the divided distance originating from one of midpoints 305 and 307 and toward the other midpoint.

To determine the center 304 of the second printhead 318, the same calculations can be applied. For example, the software can calculate the midpoint 308 between nozzles 321-1 and 321-N of second printhead 318 and divide the distance by a factor of two, and measuring the divided distance originating from one of nozzles 321-1 and 321-N and toward the other nozzle. The midpoint 306 between nozzles 322-1 and 322-N can be calculated by dividing the distance between nozzles 322-1 and 322-N by a factor of two, and measuring the divided distance originating from one of nozzles 322-1 and 322-N and toward the other nozzle. The software can calculate the center 304 of the second printhead 318 by calculating the distance between the midpoints 306 and 308, dividing that distance by two, and measuring the divided distance originating from one of midpoints 306 and 308 and toward the other midpoint.

The software can calculate an intersection point 360, which is positioned horizontally from the first center 301 and vertically from the second center 304. The linear offset distance 372 can be measured by calculating the distance between the Y coordinate of the second center 304 of the second printhead 318 and the Y coordinate of the intersecting point 360. The distance measured represents the linear offset 372 between the first printhead 316 and the second printhead 318 in the Y-axis direction 351.

The software can calculate the offset distance data and send instructions for adjusting nozzle ink ejection timing according to the offset distance calculated above to a processor. The processor can provide a controller with alignment data to adjust nozzle ink ejection timing of one or more printheads in the Y-axis direction 351. That is, the controller can initiate a printhead ink ejection timing algorithm of the second printhead 318 after the print media 390 advances through a distance substantially equal to the linear offset distance 372 between the first printhead and the second printhead in the Y-axis direction 351 such that, for example, a continuous substantially horizontal line across the width of both printheads can be printed.

In the embodiment shown in FIG. 3C, software can calculate a linear offset distance 374 in the X-axis direction 353. Linear offset distance 374 can correspond to nozzle overlap zone 120 shown in FIG. 1. The embodiment in FIG. 3C shows an ink placement pattern with a linear offset between two staggered, stationary printheads 316 and 318. The four solid lines 310, 320, 330, and 340 illustrate the ink placement pattern printed by two printheads on print media 390 and appear offset in both an X-axis 353 direction and a Y-axis direction 351 however, for purposes of illustration and not for limiting the embodiments, adjustment of the two printheads is illustrated with respect to the X-axis direction only 353.

The image scanning mechanism, such as the scanning mechanism 154 shown in FIG. 1, can detect the ink placement pattern and software can operate on data regarding the ink placement pattern that is received from the image scanning mechanism. In the embodiment shown in FIG. 3C, the ink placement pattern data can be scanned by the image scanning mechanism 154 and sent to memory, such as memory 142 shown in FIG. 1. By way of example, and not by way of limitation, the data can be analyzed by a software program that operates on the data by identifying certain X and Y coordinates of a first printhead 316 and a second printhead 318, as for example, the X and Y coordinates representing points 312-N and 321-1. The software can calculate an intersection point 362, which is positioned vertically from an X and Y coordinate on the first printhead 316, as for example, from point 312-N and positioned horizontally from an X and Y coordinate on the second printhead 318, as for example, point 321-1. The linear offset distance 374 can be measured by calculating the distance between the X coordinate of point 321-1 and the X coordinate of the intersection point 362. The distance measured represents the linear offset or nozzle overlap zone 374 between the nozzles of first printhead 316 and the nozzles of the second printhead 318 in the X-axis direction 353.

The software can calculate the offset distance and send instructions for adjusting nozzle firing according to the linear offset distance 374 in the X-axis direction 353 to a processor, such as the processor 144 shown in FIG. 1. In particular, the processor can provide a controller with linear offset distance 374 to disable nozzles that cause redundant ink drop ejection within nozzle overlap zone. That is, the controller can initiate an algorithm that can control the adjustment of nozzle ink ejection of the overlapping nozzles between the first printhead 316 and the second printhead 318 so as to reduce banding effects in printed images where the banding is a result of the ink ejection from a number of ink nozzles at the same location on the print media.

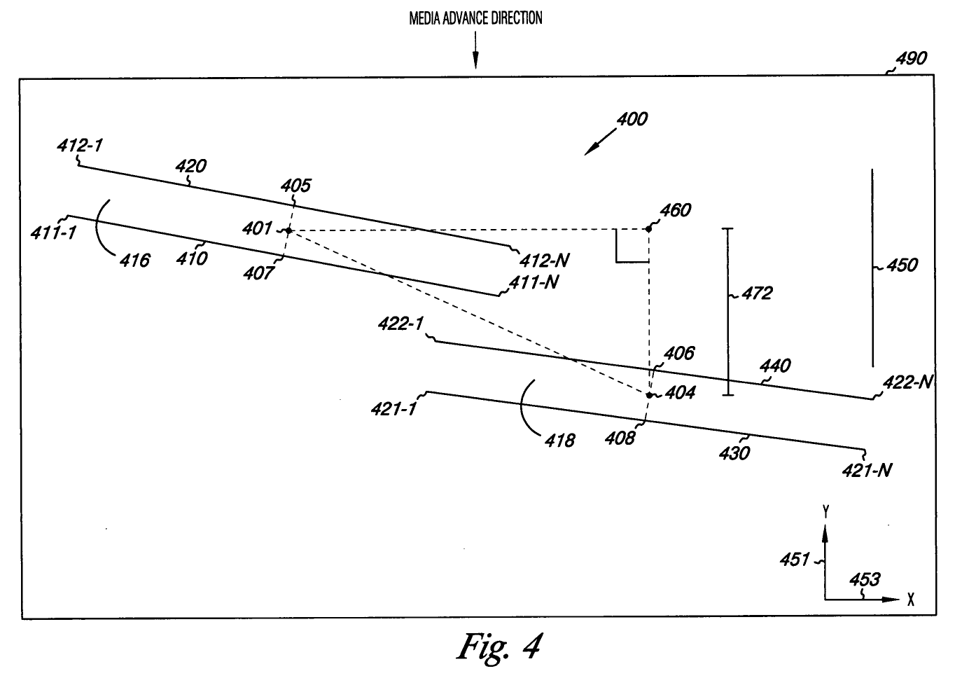

FIG. 4 illustrates a more detailed description of the embodiment illustrated in FIG. 3B. In the embodiment of FIG. 4, adjustment of a linear offset 472 relative to a linear distance between a first and a second printhead in the Y-axis direction 451 is shown. As one of ordinary skill will understand, the illustrated embodiment is not limited to linear alignment between first and second printheads in a Y-axis direction 451. The embodiments shown herein can calibrate printheads along an X-axis direction 453 and can calibrate rotationally relative to a vertical reference line 450.

In the embodiment of FIG. 4, an ink placement pattern 400 is printed on print media 490 using two staggered, stationary printheads 416 and 418, each printhead comprising a number of columns with “N” number of nozzles, for example, two columns with N number of nozzles are shown in this embodiment. In the embodiment shown in FIG. 4, the first and second printheads simultaneously eject ink from all of the nozzles in the first and second columns of both printheads thereby printing ink drop lines 410, 420, 430, and 440. The reference line illustrated by ink drop line 450 is printed as the media advances during the printing of the ink placement pattern by repeatedly ejecting ink from one nozzle of one column of one printhead. For example, in the embodiment shown in FIG. 4, the vertical reference line 450 is printed by ejecting ink from the right most nozzle 422-N in the second column of second printhead 418.

An image scanning mechanism, such as the image scanning mechanism 154 shown in FIG. 1, can be used to detect the ink placement pattern and software can operate on the data received from the image scanning mechanism. The software can identify X and Y coordinates of midpoint 407 by identifying X and Y coordinates representing nozzles 411-1 and 411-N. By identifying those coordinates, the software can measure the distance between nozzles 411-1 and 411-N, divide the distance between those nozzles by a factor of two, and measure the divided distance originating from one of nozzles 411-1 and 411-N and toward the other nozzle to determine the X and Y coordinates of midpoint 407.

The software can identify X and Y coordinates of midpoint 405 by identifying X and Y coordinates representing nozzles 412-1 and 412-N. By identifying those coordinates, the software can measure the distance between nozzles 411-1 and 411-N, divide the distance between those nozzles by a factor of two, and measure the divided distance originating from one of nozzles 412-1 and 412-N and toward the other nozzle to determine the X and Y coordinates of midpoint 405.

The X and Y coordinates of the center 401, which is a non-scanned data point representing the center of the first printhead using the measured distance between midpoints 405 and 407, can be calculated by dividing the measured distance between those midpoints by a factor of two, and measuring the divided distance originating from one of midpoints 405 and 407 and toward the other midpoint. For example, software can measure the divided distance originating from midpoint 405 and toward midpoint 407. The point at which the divided distance in the direction of the midpoint 407 terminates represents the center 401.

The software can identify X and Y coordinates of midpoint 408 by identifying X and Y coordinates representing nozzles 421-1 and 421-N. By identifying those coordinates, the software can measure the distance between nozzles 421-1 and 421-N, divide the distance between those nozzles by two, and measure the divided distance originating from one of nozzles 421-1 and 421-N and toward the other nozzle to determine the X and Y coordinates of midpoint 408.

The X and Y coordinates of midpoint 406 can be determined by identifying X and Y coordinates representing nozzles 422-1 and 422-N. By identifying those coordinates, the software can measure the distance between nozzles 422-1 and 422-N, divide the distance between those nozzles by a factor of two, and measure the divided distance originating from one of nozzles 422-1 and 422-N and toward the other nozzle to determine the X and Y coordinates of midpoint 406.

The software can calculate the X and Y coordinates of the center 404, which is a non-scanned data point representing the center of the second printhead using the measured distance between midpoints 406 and 408, dividing the measured distance between those midpoints by a factor of two, and measuring the divided distance in the direction of the other midpoint. For example, the software can measure the divided distance originating from midpoint 406 and toward midpoint 408. The point at which the divided distance in the direction of the midpoint 408 terminates represents the center 404.

The distance between the center 401 of the first printhead 416 and the center 404 of the second printhead 418 can be measured by software. To determine the distance between the first and second printheads in the Y-axis direction, the software can measure the X and Y coordinates 460, which is a vertical and horizontal point intersection resulting in a right triangle. The intersection point 460 can be determined by the software by positioning a vertical line from the center 404 and positioning a horizontal line from the center 401. The software can calculate the linear offset distance 472 in the Y-axis direction 451 by measuring the distance between 404 and 460. That measured distance can be used as input to a timing algorithm in the Y-axis direction 451 such that, for example, a continuous horizontal line across the width of both printheads can be printed.

As one of ordinary skill in the art will appreciate, the linear offset distance between printheads in the Y-axis direction 451 can be obtained by using a variety of X and Y coordinates. For example, in FIG. 4, the software can utilize the X and Y coordinates 412-1 on the first printhead 416 and the X and Y coordinates 422-1 on the second printhead 418. The software can measure a vertical line originating from 422-1 and a horizontal line originating from 412-1. The point at which the vertical and horizontal points intersect, i.e., intersecting data point, results in a right triangle. The software can measure the distance between 422-1 and the intersecting data point. The measured distance represents the linear offset distance between the first and second printheads in the Y-axis direction 451.

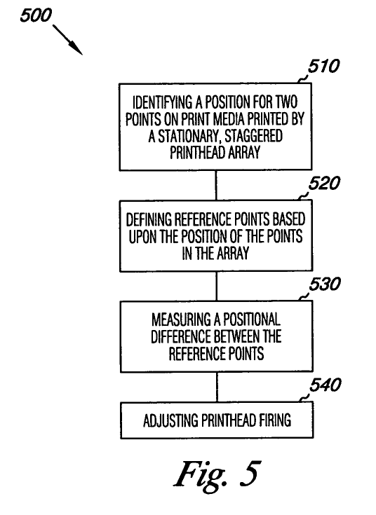

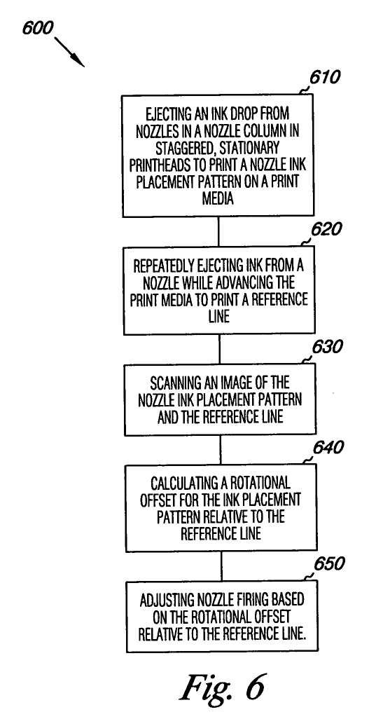

FIGS. 5 and 6 illustrate method embodiments for printhead adjustment. The methods can be performed by executable instructions operated on by a controller, interface electronics, and other components as described above. Unless explicitly stated, the method embodiments described herein are not constrained to a particular order or sequence. Additionally, some of the described method embodiments or elements thereof can occur or be performed at the same point in time. FIG. 5 illustrates a method embodiment for printhead adjustment. In block 510, the method includes identifying a position for two points on print media printed by a stationary, staggered printhead array. The two points on print media printed by the stationary, staggered printhead array can include points at the center of two ink pattern lines. In various embodiments, the two points in the printhead array can also include endpoints of at least one ink pattern line.

In block 520, the method can also include defining two reference points based upon the position of the two points. The two reference points can include points on a reference line such that an imaginary line drawn from a reference point to a point on print media printed by the stationary, staggered printhead array forms a right angle between the reference line and the imaginary line. In various embodiments, two printheads can each have an overlapping endpoint and the two reference points can include one overlapping endpoint and an intersecting point that is positioned at a right angle intersection of imaginary lines drawn from each overlapping endpoint. In various embodiments, the two points on print media printed by the stationary, staggered printhead array can include points at the center of two ink pattern lines and the two reference points can include one center point and an intersecting point that is positioned at a right angle intersection of imaginary lines drawn from each center point.

The method can also include measuring a positional difference between the two reference points in block 530. In block 540, the method can also include adjusting printhead ink ejection according to the positional difference. The method can include adjusting printhead ink ejection during a print job.

The method of FIG. 5 can include ejecting an ink drop from one or more nozzles in a nozzle column of at least two staggered, stationary printheads to print a nozzle ink placement pattern on a print media, repeatedly ejecting ink from at least one nozzle while advancing the print media to print a reference line in the direction of advancement of the print media, scanning an image of the nozzle ink placement pattern and the reference line, and adjusting nozzle ink ejection timing based on the rotational offset relative to the reference line.

FIG. 6 illustrates a method embodiment for printhead adjustment. In block 610, the method includes ejecting an ink drop from two or more nozzles in a nozzle column in at least two staggered, stationary printheads to print a nozzle ink placement pattern on a print media. The method also includes repeatedly ejecting ink from a nozzle while advancing the print media to print a reference line at block 620. In block 630 the method includes scanning an image of the nozzle ink placement pattern and the reference line. The method also includes calculating a rotational offset for the ink placement pattern relative to the reference line at block 640. In block 650, the method includes adjusting nozzle ink ejection timing based on the rotational offset relative to the reference line.

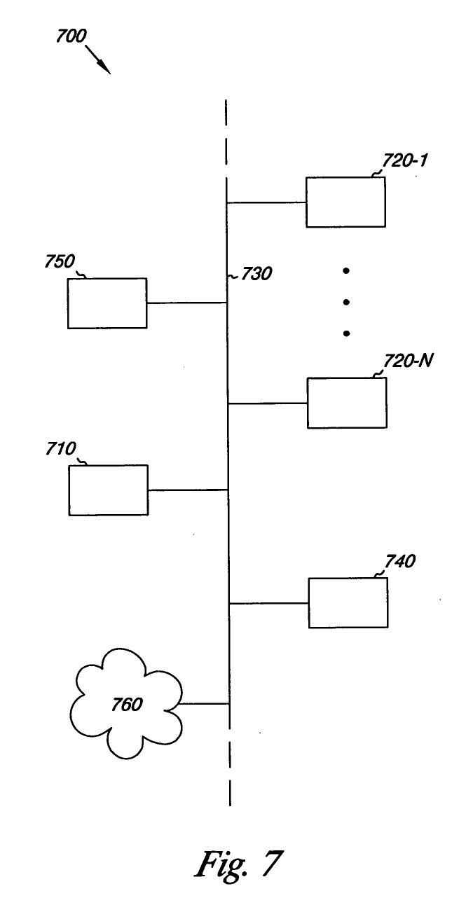

FIG. 7 illustrates an embodiment of a printing device 710 networked in a system environment 700. The printing device 710 can include a printing device with ink placement adjustment capability according to the embodiments that have been described herein. In the embodiment of FIG. 7, the system printing device 710 can be illustrated networked to a number of remote devices, 720-1 to 720-N, via a number of data links 730. As illustrated in FIG. 7, the printing device can further be connected to other peripheral devices 740, e.g., other scanning device or fax capable devices, to a storage device 750, and to Internet access 760. The remote devices, 720-1 to 720-N, can include a desktop computer, laptop computer, a workstation, a server, a hand held device (e.g., a wireless phone, a personal digital assistant (PDA)), or other devices as the same will be known and understood by one of ordinary skill in the art.

The number of data links 730 can include one or more physical connections, one or more wireless connections, and/or any combination thereof. The networked system environment shown in FIG. 7 can include any number of network types including, but not limited to, a Local Area Network (LAN), a Wide Area Network (WAN), a Personal Area Network (PAN), and a Wireless-Fidelity (Wi-Fi) network, among others.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus for printhead adjustment, comprising:
an image scanning mechanism to provide positioning data about the position of drops of ink ejected onto media from nozzles of a number of stationary printheads; and
a controller to determine a Y axis offset of at least two ink drops based on the positioning data.

2. The apparatus of claim 1, wherein the controller is operable to adjust ink ejection timing of a number of nozzles based upon the determined Y axis offset.

3. The apparatus of claim 1, wherein the controller interprets the data to identify the Y axis offset between at least two ink drops ejected from two different of the stationary printheads.

4. The apparatus of claim 1, wherein the controller interprets the data to identify a rotational offset of at least two ink drops.

5. The apparatus of claim 4, wherein the controller interprets the data to identify a rotational offset of at least two ink drops ejected from one of the stationary printheads.

6. The apparatus of claim 1, wherein the controller is operable to interpret the data to identify the positioning of the ink drops with respect to a print media advancement direction.

7. The apparatus of claim 6, wherein the print media advancement direction is calculated based upon the position of a reference line.

8. The apparatus of claim 1, wherein the controller is operable to determine a rotational offset of at least two ink drops with respect to a reference line and adjust ink ejection timing of a number of nozzles based upon the rotational offset.

9. The apparatus of claim 1, wherein the apparatus has at least two stationary printheads having a nozzle overlap zone, and wherein the controller is operable to adjust ink ejection of a number of the nozzles based upon an X axis offset to reduce redundant ink drop ejection within the nozzle overlap zone.

10. An image forming system, comprising:
at least two printheads each having a number of nozzles thereon,
wherein the printheads are configured in a staggered, stationary array for forming an image on print media;
a scanning mechanism for scanning ink placement pattern information; and
a controller to determine X and Y axis offsets of at least two printheads based upon the ink placement pattern information.

11. The image forming system of claim 10, wherein the controller is operable to determine a rotational offset relative to a reference line.

12. The image forming system of claim 11, wherein the reference line represents a print media advancement direction.

13. An apparatus for printing, comprising:
an image scanning mechanism to provide positioning data about positioning of a number of nozzles of at least two stationary, staggered printheads; and
means for determining X and Y axis offsets of the printheads based on the positioning data.

14. The apparatus of claim 13, wherein the means for determining X and Y axis offsets includes determining a number of reference points and determining a positional difference between at least two of the number of reference points.

15. The apparatus of claim 14, further including means for adjusting at least one printhead based on the positional difference.

16. The apparatus of claim 15, wherein means for adjusting includes adjusting an ink ejection time of at least one nozzle.

17. The apparatus of claim 13, further includes means for determining a rotational offset of at least one printhead.

18. A method for ink pattern adjustment, comprising:
identifying a position for two points on print media printed by a stationary, staggered printhead array;
defining two reference points based upon the position of the two points;
measuring a positional difference between the two reference points; and
adjusting printhead ink ejection according to the positional difference.

19. The method of claim 18, wherein the two points on print media printed by the stationary, staggered printhead array include points at the center of two ink pattern lines.

20. The method of claim 18, wherein the two points in the stationary, staggered printhead array include endpoints of at least one ink pattern line.

21. The method of claim 18, wherein the two reference points include points on a reference line such that an imaginary line drawn from a reference point to a point printed by the stationary, staggered printhead array forms a right angle.

22. The method of claim 18, wherein two ink pattern lines each have an overlapping endpoint and wherein the two reference points include one overlapping endpoint and an intersecting point, that is positioned at a right angle intersection of imaginary lines drawn from each overlapping endpoint.

23. The method of claim 18, wherein the two points in the stationary, staggered printhead array include points at the center of two printheads and wherein the two reference points include one center point and an intersecting point, that is positioned at a right angle intersection of imaginary lines drawn from each center point.

24. A computer readable medium having a set of executable instructions for causing a device to perform a method, comprising:
identifying a position for two points on print media printed by a stationary, staggered printhead array;
defining two reference points based upon the position of the two points;
measuring a positional difference between the two reference points; and
adjusting printhead ink ejection according to the positional difference.

25. The computer readable medium of claim 24, the method wherein adjusting printhead ink ejection includes adjusting during a print job.

26. A computer readable medium having a set of executable instructions for causing a device to perform a method, comprising:
ejecting an ink drop from two or more nozzles in a nozzle column of at least two staggered, stationary printheads to print an ink placement pattern on a print media;
repeatedly ejecting ink from a nozzle while advancing the print media to print a reference line;
scanning an image of the ink placement pattern and the reference line;
calculating a rotational offset for the ink placement pattern relative to the reference line; and
adjusting nozzle ink ejection timing based on the rotational offset relative to the reference line.
